(19) United States
(12) Patent Application Publication
(10) Pub. No.: US 2003/0066432 A1
(43) Pub. Date: Apr. 10, 2003

(54) Food-turnover making machine and method

(76) Inventor: Juan D. Arango, Miami, FL (US)

Correspondence Address: JUAN ARANGO, 14350 SW 112 Terrace, MIAMI, FL, 33186, US

(21) Appl. No.: 09/970,097

(22) Filed: Oct. 4, 2001

(51) Int. Cl. A23L 1/00

(52) U.S. Cl. 99/353; 99/450.1

(57) ABSTRACT

A food-turnover making method and machine invention is capable to produce turnovers sealed and ready to be post-processed by simple combined action between forming rollers and conveyor belt over a flat dough and desired inner filling, all in a single step. Being turnovers different forms and sizes by interchanging forming rollers accordingly to the type or size to be produced.

### STATEMENT REGARDING FEDERALLY SPONSORED RESEARCH OR DEVELOPMENT

Not applicable

### REFERECE TO A MICROFICHE APPENDIX

Not applicable

### BACKGROUND OF THE INVENTION

This invention relates to a method and apparatus for enveloping food products in which the food products are placed upon a conveyor belt and where the food product are subject to a folding-enclosing operation. In particular, the enveloped food product comprise a flat preformed dough folded-enclosed around a filling such as meat, meat-potatoes, beans, or other and which may subsequently be fried or baked.

Existing all around the world, typical encrusted food and particularly encrusted food made out from a flat raw edible material bend over a filling usually called turnover and to be specific Food-Turnover, Food-Turnover has different names around the world. Some names to Turnovers are Beerock, Pasty, Calzone, Pizza pocket, Empanada, Patty, Risol, Salteña and other. There are different forms to do food-turnovers they start from purely manual to more complex one. Usually the hand made process takes extensive time and that hand operation produces a product somewhat characterized by inconsistent or uneven appearance and to some degree, not necessary in the best quality characteristics. When is done with some tools that bring some advantages over full manually method, the process improved and the product gets better quality but is also time consuming. There are also different apparatus that let these food products to be made in some semi-automated fashion bringing more uniformity to the product and speeding up the process. It is known from U.S. Pat. No. 3,757,676 a machine to prepare Mexican tacos and Mexican enchiladas. The U.S. Pat. No. 3,757,676 principal object recites “ . . . a machine which automatically prepares filled food products such Mexican tacos . . . ” and after this within the operation description (Column 9, lines 33-34) also recites “ . . . a small arcuate flap portion 90c which may be folded over against the envelope portion when packing . . . ” therefor, even tough you could considered this machine automatic, there is one additional step that should be performed over called final product and it is not done by the machine. This final step has to be performed in addition to the work done by the machine and increase the necessity for labor or other apparatus. Also distort the desired uniformity products should have.

The increased demand for turnovers and alike, makes highly desirable a system for the production of large quantities of such food products at a rapid rate and with repeatable consistency of quantity, physical appearance, and the like.

### BRIEF SUMMARY OF THE INVENTION

The present invention solved the problems of producing turnovers or alike at a rapid rate with consistent quality and with no handwork. This invention provides an elongated frame, conveying means, closing-sealing means and driven means. More specifically, this invention provides a food processing machine which includes a product forming conveyor belt having an input end and a discharge end and a product forming portion between such ends for folding a substantially flat cake, dough or pastry shell into an envelope for containing a food filler. The forming portion of the flexible conveyor belt is guided into a U-shaped folding shape by a pair of laterally Forming rollers disposed on opposite sides of the upper product conveying section of the belt. A feed conveyor is positioned at the input end of the forming belt conveyor. A filling dispensing output from a dispensing equipment is required to be located over the feed conveyor for depositing a measured quantity of food filler on each shell moved along the feed conveyor.

The product shells are sequentially introduced into the system from a suitable source such as belt at the discharge end of a tortilla machine. As the shells each enter the machine, measured quantities of a food filler, such as meat paste or alike, are deposited on each of the shells. The shells then moved along the forming belt conveyor on which they are formed into a filler-containing envelope. The machine folded and sealed simultaneous around the filler without leaving any arcuate or border portion to be sealed when packaging being this an improvement over previous art because seals along the border whatever form this border has. Each product is then discharged from the forming belt for packaging or post-processing.

This invention forming rollers let food product be ready for post-processes without the arcuate flap portion that required further folding. Then because the more advanced forming rollers this machine has the capability of a full enclosing the food doing so along the border.

It is a principal object of this invention to provide a method and apparatus that automatically prepares folded food products such as turnovers or alike at a rapid rate, with consistent quality and with no handwork.

It is a further object of the invention to provide a method and apparatus by which a food product is subjected to a fold-seal while being advanced on a conveyor belt for forming a filled contained envelope food product.

It is still a further object of the method and apparatus of the invention to receive a flat food product and seals the food filled within the shell after folding around the food filler.

It is also an object of the method and apparatus of the invention to provide a food processing apparatus, which may be utilized in either single or multiple row fashion for producing large quantities of food products at a rapid rate.

It is an additional object of the method and apparatus of the invention to provided a high efficiency producing turnovers due to few parts, ease to operate with minimum or no trimming at all machine.

These and other objects and additional elements, features and advantages of the method and apparatus of the invention will be better understood from the following detail description taken in conjunction with the accompanying drawings.

### BRIEF DESCRIPTION OF THE DRAWINGS

FIG. 1 Turnover apparatus general view. This isometric view shows a single-row Food-turnover making machine.

FIG. 2 Forming head. This Figure shows the forming head (No details to forming rollers).

FIG. 3 Forming rollers. This is a Front view of the Forming Rollers.

FIG. 4 Forming rollers. This is a Side view of the Forming Rollers.

FIG. 5 Forming rollers. This is a Top view of the Forming Rollers.

FIG. 6 Typical product, Moon shaped is shown,

FIG. 7 Typical product, Rectangular or Pizza Pocket shape is shown.

FIG. 8 Typical product, Moon shape, is shown.

FIG. 9 Typical product, Gross sectional view, is shown.

### DETAIL DESCRIPTION OF THE INVENTION

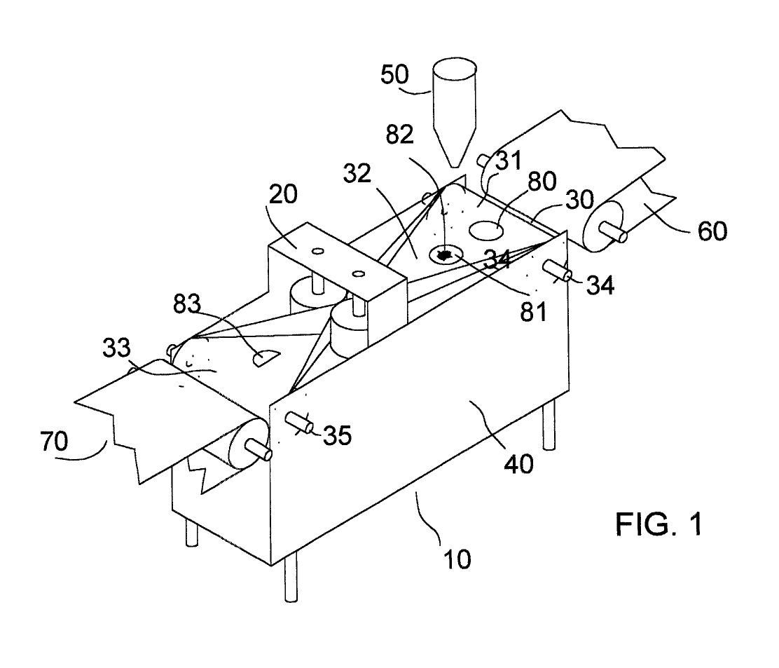

The Invention general view drawing FIG. 1 shows the turnover apparatus 10 to close and to seal turnovers. The turnover apparatus 10 includes forming-head 20, conveyor belt 30, the machine frame 40, filling manifold 50 as well as a feed conveyor 60 and discharge conveyor 70. The conveyor belt has a flat belt 32 and two end rollers 34 and 35 being one end a conveyor belt entrance 31 and the opposite the conveyor belt exit 33. On the conveyor belt entrance end 31, you see a flat round dough or shell 80 and a flat round shell 81 that has the desired food filling 82 and on the conveyor exit end 33 you can see one formed turnover 83.

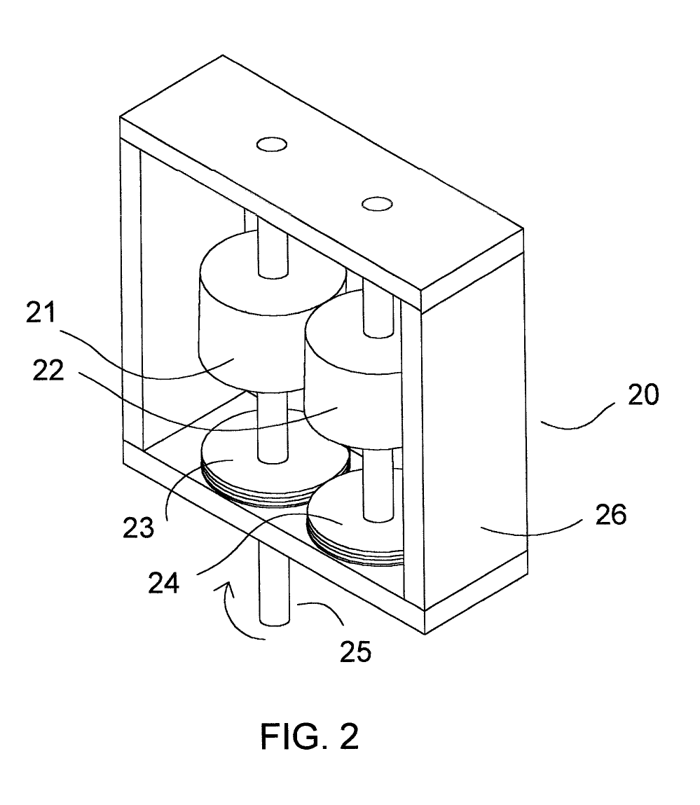

FIG. 2 shows the Forming head 20, forming rollers 21 and 22, both of them equals, and synchronism means gear 23 and gear 24, also equals, as well as the propulsion intake shaft 25 and the forming head body 26. Driving means goes to shaft 25 to drive one forming roller and by synchronism means 23 and 24 the other forming roller is driven. Both forming rollers work together to drive the conveyor belt flat belt 32. To get better performance you can also have and extra mechanism to drive conveyor belt end rollers 34 and 35.

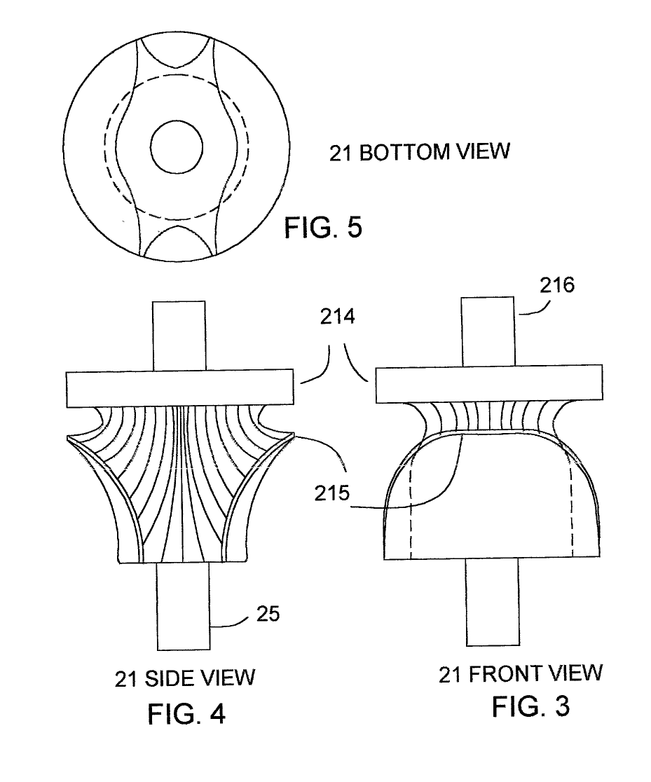

FIGS. 3, 4 and 5 are shown details from a particular design of a forming roller in three different views front view, side view and top view. FIG. 3 is shown the front view. FIG. 4 is shown the side view and FIG. 5 is shown the bottom view. FIG. 3 and FIG. 4 show conveyor belt's driving wheel 214 as well as closing-sealing lips 215. Upper shaft 216 and lower driven shaft or the propulsion intake shaft 25. FIG. 5 Shows timing points 217 that are used to synchronize the two forming rollers. The forming rollers shown produce a moon shape turnover. Beside different products forms the machine can produce different products sizes with their corresponding forming rollers shape and size.

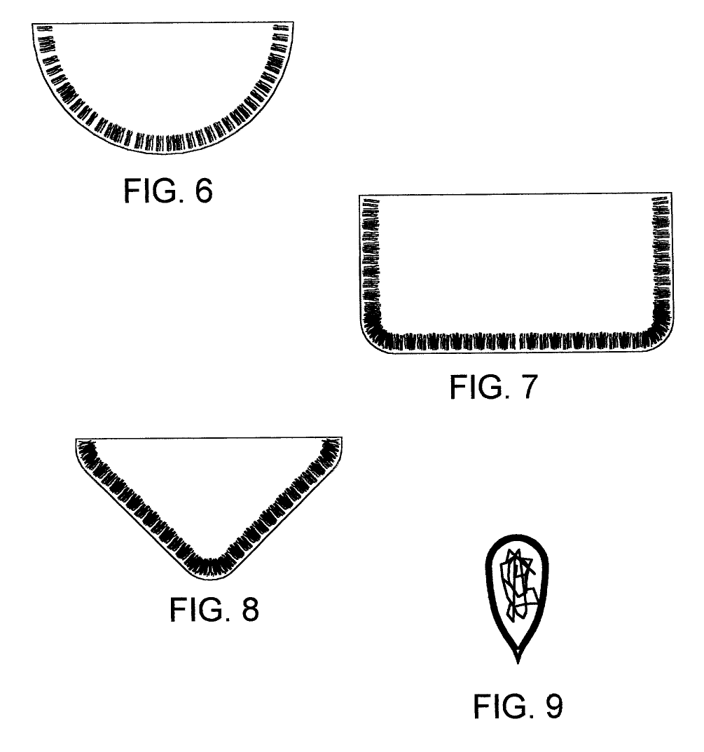

FIGS. 6, 7 and 8 are shown typical products that can be made by the turnover machine. FIG. 6 is shown the moon shape turnover, possibly the most common one. FIG. 7 is shown the rectangular shape turnover or pizza pocket shape turnover. FIG. 8 is shown the triangular shape turnover.

FIG. 9 is shown a turnover section view from this invention method and apparatus. Please note the symmetry between both sides that has been obtained by this turnover machine. This symmetry characterizes the production made out from this invention method and apparatus.

This invention apparatus operation starts when the machine 10 receives the shell 80 at the entrance end 31 from a tortilla machine (not Shown) through a feed conveyor 60 or is deposited directly from the tortilla machine over the conveyor belt entrance 31. The choice to use a feed conveyor 31 depends from the particular characteristics of the tortilla machine. After shell is being received the forming conveyor moves the shell under a filling manifold 50 and the filling manifold dispenses the desired filling 82 that is dispensed when the shell still moving on the belt 32 of the forming conveyor belt. Further the belt 32 of the forming conveyor belt is bend at forming-head 20 by the combined action of forming rollers and belt end rollers 35 and 36. While still moving forward on the belt 32 the shell is bent by the previous mentioned bend action over the belt 32 of the forming conveyor belt and enters the forming rollers action, particularly the one exerted by closing-sealing lips 215, that progressively and combinable with the belt closes and seals the turnover The belt 32 is driven by the forming-head driving wheel 214 and the end rollers 34 and 35 of the forming conveyor belt 30 whose at the same time are driven by means not shown but takes movement action as explained early on in this document After closed-sealed the turnover is carried out to the exit end by the conveyor belt and after this for a discharge conveyor 70 from here on the turnover can be post-processed.

The machine may be constructed for single row production or multiple row production. In multiple row use a plurality of the apparatus may be simple aligned in parallel side by side relationship or the functional components of the system, as for example the filler dispensing, the forming belts, and the related structure as the forming head and filling manifold, are provided for each production row desired. The machine is capable of an exceptionally high production rate, as for example, each row of a combination machine formed by several production lines, is capable of processing several hundred products per minute.

What I claim as my invention is:

1. A method for preparing a food product having an outer shell bent and sealed around an inner filler comprising the steps of
(a) conveying the flat dough and said inner filler over a flat belt, and
(b) folding said flat belt within coordinated action with a forming rollers so half of said flat dough goes to the other half part of said flat dough enclosing said inner filler in said flat dough,
whereby said flat dough forms said shell for said inner filler producing a turnover.

2. An apparatus for preparing a food product having an outer shell bent and sealed around an inner filler comprising
(a) means for conveying the flat dough an said inner filler from an entrance section to an exit section throughout a,
(b) means for bending said means for conveying the flat dough that enable combined action between said conveying means and said bending means for folding and for sealing said flat dough for enclosing said inner filler,
whereby said flat dough forms said shell for said inner filler producing a turnover.

3. An apparatus for preparing a food product having an outer shell bent and sealed around an inner filler in accordance with claim 2 further including
(a) means for driving at least said means for bending said means for conveying the flat dough, and

4. An apparatus for preparing a food product having an outer shell bent and sealed around an inner filler in accordance with claim 2 further including
(a) means for dispensing said inner filler over said flat dough

5. An apparatus for preparing a food product having an outer shell bent and sealed around an inner filler in accordance with claim 2 further including
(a) means for feed said flat dough, and
(b) means for discharge said turnover.

6. An apparatus for preparing a food product having an outer shell bent and sealed around an inner filler in accordance with claim 2 wherein
(a) said means for conveying the flat dough an said inner filler is a conveyor belt having a flat belt and an end rollers supporting said flat belt moving said flat dough and said inner filler with the upper run advancing from the entrance portion toward the exit portion, and
(b) said means for bending said means for conveying the flat dough are a pair forming rollers that enable combined action between said flat belt and said pair forming rollers for folding and for sealing said flat dough for enclosing said inner filler.

7. An apparatus for preparing a food product having an outer shell bent and sealed around an inner filler in accordance with claim 2 further including
(a) an electromechanical apparatus thereby control and coordinate invention operation.

8. An apparatus for preparing a food product having an outer shell bent and sealed around an inner filler in accordance with claim 5 wherein
(a) said means for feed said flat dough is multiple choices including conveyor belt or man labor, and
(c) said means for discharge said turnover is multiple choices including conveyor belt or man labor.
